(19) United States
(12) Patent Application Publication
(10) Pub. No.: US 2011/0299870 A1
(43) Pub. Date: Dec. 8, 2011

(54) IMAGE FORMING APPARATUS

(75) Inventor: Shinya TANIGAMI, Tokyo (JP)

(73) Assignee: KONICA MINOLTA BUSINESS TECHNOLOGIES, INC., Tokyo (JP)

(21) Appl. No.: 13/150,455

(22) Filed: Jun. 1, 2011

(30) Foreign Application Priority Data
Jun. 4, 2010 (JP) JP2010-128655

(51) Int. Cl. G03G 15/00

(52) U.S. Cl. 399/82

(57) ABSTRACT

An image forming apparatus has a controller, when a continuous two-sided printing is carried out, which causes two image forming sections to print images of image data on an Nth page and an (N+1)th page onto respective surfaces of a preceding recording sheet, causes the same image forming section as the image forming section that has formed the image on the (N+1)th page to print an image of image data on an (N+2)th page onto a following sheet, causes a sheet reversing section to reverse the sheet on which the image of the (N+2)th page has printed before the sheet is ejected from the apparatus, and then controls a sheet ejection so that a surface of the (N+1)th page of the preceding sheet faces a surface of the (N+2)th page of the following sheet.

This application is based on Japanese Patent Application No. 2010-128655 filed on Jun. 4, 2010, which is incorporated hereinto by reference.

### BACKGROUND OF THE INVENTION

The present invention relates to uniformity of image quality outputted from an image forming apparatus.

There has been a proposal of an image forming apparatus wherein at least two image forming sections are provided in the image forming apparatus for improving a speed and productivity for printing by the image forming apparatus, and a speed and productivity for two-sided printing have been improved by conducting image forming on the surface and on the other side simultaneously or through one passage. However, in the case of the obverse and reverse image forming for two-sided printing by the two image forming sections, there are many dominant causes to make image quality and image tone to be different between the two image forming sections when photographs and halftone images are included in a document, resulting in a big problem for uniformity of image quality in printing on the obverse and reverse sides.

To cope with this problem, there has been a proposal for uniformity of printed image qualities by the two image forming sections. For example, in Japanese Patent Application Publication No. H11-231597, an electrification amount coincident device is provided to cope with uniformity of image qualities on both sides so that an electrification amount for the obverse image and that of the reverse image may agree with each other roughly, by measuring each amount of charging for the obverse and reverse images, in the case of collective transfer onto the sheet for the obverse and reverse images.

However, image qualities generated by the two image forming sections are not uniformed to be equal to the image quality by a single image forming section, because of the image forming conditions of the respective image forming sections which are easily dispersed and of toner polarity change relating to the obverse and reverse simultaneous transfer and additional mechanisms. In particular, when the sheet after two-sided printing by the two image forming sections is bound by a post-processing device to be constructed to a two-page spread as a booklet, a difference of image quality between the two pages is large to be remarkable because both pages spread are printed by the image forming sections which are different from each other.

### SUMMARY OF THE INVENTION

An aspect of the invention is as follows.

Item 1: An image forming apparatus having therein two image forming sections, a sheet reversing section and a controller and is capable of printing images on the obverse and reverse surfaces of a sheet by the two image forming sections, wherein the controller prints images corresponding to image data on N^{th} page and image data on (N+1)^{th} page with the aforesaid two image forming sections on a preceding sheet, in the case of continuous two-sided printing, and it prints an image corresponding to image data for (N+2)^{th} page on the following sheet with an image forming section that is the same as the image forming section that formed the image on the (N+1)^{th} page, then, it reverses the sheet on which the image on the (N+2)^{th} page is printed, before the sheet ejection, and it conducts the control to eject a sheet so that a surface of (N+1)^{th} page of the preceding sheet and a surface of (N+2)^{th} page of the following sheet may face each other.

Item 2: The image forming apparatus described in the aforesaid Item 1 equipped with a sheet finisher that forms a booklet by post-processing on a sheet on which an image has been formed, wherein the aforesaid controller controls so that images on two pages to be a two-page spread of a formed booklet may be printed by the same image forming section.

Item 3: The image forming apparatus described in the aforesaid Item 2 characterized to have a selectable section that can be selected so that images on two pages that can be made to be a specific two-page spread by a user may be printed by the same image forming section before the booklet is formed in the sheet finisher.

### BRIEF DESCRIPTION OF THE DRAWINGS

FIG. 1 is a general view of an image forming apparatus relating to the invention.

FIG. 2 is a control block diagram relating to the invention.

Each of FIGS. 3A-3C is an explanation drawing of a “regular mode”.

Each of FIGS. 4A-4C is an explanation drawing of a “two-page spread image quality coincident mode”.

Each of FIGS. 5A-5C is an explanation drawing of a “specified page selection mode”.

FIG. 6 is a flow chart for the control relating to the invention.

FIG. 7 is a flow chart for the control relating to the invention.

FIG. 8 is an output setting drawing relating to the invention.

FIG. 9 is an output setting drawing relating to the invention.

FIG. 10 is a specified page selection drawing relating to the invention.

### DETAILED DESCRIPTION OF THE PREFERRED EMBODIMENT

The present invention will be explained in detail as follows, referring to the embodiment, to which however, the invention is not limited.

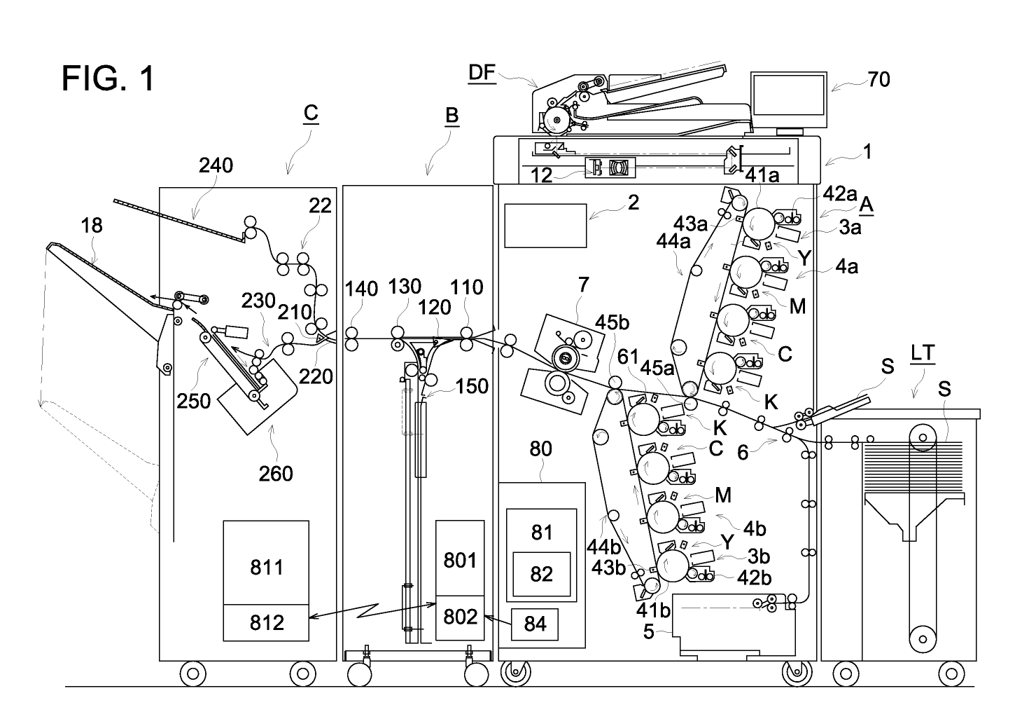

FIG. 1 is a general view of an image forming apparatus relating to the invention. The image forming apparatus is composed of image forming apparatus main body A, automatic document feeder DF, large capacity sheet tray LT, sheet reversing and ejecting section B and sheet finisher C, and operation section 70 is provided on the image forming apparatus main body A. Each of these items may either be of the construction wherein separate items are connected, or be of the one-body construction. The automatic document feeder DF sends documents to document reading section 1 one by one, and causes document reading sensor 12 to read to document reading control section 2 as image data. The image data thus have been read in the document reading control section 2 are A/D-converted and are corrected in terms of image quality after shading correction, and are recorded on image memory 81 structured to be controller 80 on a page unit.

The image data in a page unit recorded in an image memory 81 are processed by the controller 80 based on setting information from operation section 70, and after that, the image data are housed in page memory 82 structured to be image memory 81 in the order of pages printed in a unit of one page. Image data in a unit of one page on the page memory 82 are utilized as writing data for writing sections 3a and 3b whose light sources are laser light sources of two image forming sections 4a and 4b, and are developed to be toner images at the two image forming sections 4a and 4b.

The sheet is fed out to sheet feeding and conveying section 6 from sheet feeding section 5 or from large capacity sheet feeding tray LT one sheet by one sheet to be conveyed through a conveyance path. Toner images are transferred onto both sides of the sheet by the two image forming sections 4a and 4b, and they are fixed on the sheet at fixing section 7.

The aforesaid two image forming sections 4a and 4b are completely symmetrical with sheet conveyance path 61 interposed between the two image forming sections 4a and 4b, and both of them have the same functions. In the recent trend wherein speeding up of printing is advancing, the demand for two-sided printing is increased under a background of the natural resources saving in particular, and there have been proposals for equipments wherein speeding up two-sided printing attained, namely, productivity of two-sided printing is enhanced by various countermeasures. The construction which will be explained here is also one of these equipments, and it is one wherein two image forming sections are provided vertically to interpose a sheet conveyance path, and printings for the obverse and reverse surfaces are conducted simultaneously while a sheet is moved and conveyed in the image forming apparatus in the case of continuous two-sided printing. Operations of one passage two-sided simultaneous printing will be explained simply.

First, there will be given an explanation for the first image forming section 4a that is provided on an upper surface of a sheet conveyance path and conducts printing on an upper surface of a sheet on the sheet conveyance path. The first image forming section 4a develops an electrostatic latent image formed on image carrier 41a to be a toner image with developing device 42a, and it transfers the toner image onto intermediate transfer belt 44a with transfer section 43a. This developing of a toner image by the developing device 42a and transfer onto the intermediate transfer belt 44a are conducted respectively for each of 4 colors of Y, M, C and K, and toner images each being in a different color are superimposed on the intermediate transfer belt 44a, to be transferred onto sheet S at transfer section 45a, and they are formed to be a color image on the upper surface of the sheet.

In the same way, there will be given an explanation for the second image forming section 4b that is provided on a lower surface of a sheet conveyance path and conducts printing on a lower surface of a sheet on the sheet conveyance path. The second image forming section 4b develops an electrostatic latent image formed on image carrier 41b to be a toner image with developing device 42b, and it transfers the toner image onto intermediate transfer belt 44b with transfer section 43b. This developing of a toner image by the developing device 42b and transfer onto the intermediate transfer belt 44b are conducted respectively for each of 4 colors of Y, M, C and K, and toner images each being in a different color are superimposed on the intermediate transfer belt 44b, to be transferred onto sheet S at transfer section 45b, and they are formed to be a color image on the lower surface of the sheet.

In the present example, polarity of toner used in the first image forming section 4a is opposite to that of toner used in the second image forming section 4b, thus, it is possible to transfer a toner image on intermediate transfer belt 44b of the second image forming section 4b onto the lower surface of the sheet with transfer section 45b, while keeping the toner image transferred onto the upper surface of the sheet from intermediate transfer belt 44a of the first image forming section 4a at the transfer section 45a, as it is.

As a matter of course, it is also possible to transfer on a sheet without disturbing a toner image of the first image forming section 4a from which the toner image of the second image forming section 4b has been transferred, by reversing polarity for the toner image transferred onto the sheet by the first image forming section 4a between the first image forming section 4a and the second image forming section 4b, by utilizing toner having the same polarity for the first image forming section 4a and the second image forming section 4b. Further, it is naturally possible to transfer the toner image of the image forming section 2 onto the lower surface of the sheet by fixing the toner image on the upper surface of the sheet by providing a fixing device, after transferring the toner image of the first image forming section 4a.

In the constitution of two image forming sections 4a and 4b in the present example, image data sent to respective writing sections 3a and 3b are determined for page adjustment in the case of bookbinding of a booklet in sheet finisher C by controller 80, which will be described in detail later. Further, a printing mode that is a characteristic of the invention, can select “regular mode” which is highest in speed and in productivity, “two-page spread image quality coincident mode” wherein image qualities of all facing pages are made to be coincident when a booklet is completed and “specified page selection mode”.

After images are transferred onto the obverse and reverse sides of the sheet, the toner images on the obverse and reverse sides of the sheet are fixed on the sheet at fixing section 7 as images. Then, the sheet reversing that is needed for page adjustment is conducted for binding a booklet, at sheet reversing section B.

The sheet on which the images are printed on both sides of the sheet at the image forming apparatus A is conveyed to sheet reversing section B. When the sheet reversing is needed, switching gate 120 wherein sheet reversing control section 801 is positioned to be immediately after entrance roller 110 of sheet reversing section B is controlled to conduct reversing operation by switching the direction of conveyance of the sheet to reversing path 150. When ejecting the sheet without reversing, the sheet is conveyed to sheet finisher C by conveyance rollers 130 and 140 under the condition that the switching gate 120 is not switched by the sheet reversing control section 801.

In the sheet finisher C, sheets each being printed on its both sides including the obverse and reverse sides which have been subjected to page adjustment are made to be a booklet automatically through stapling, center stapling and gluing bookbinding, to be ejected. In the example shown in FIG. 1, there is described sheet finisher C of a stapling bookbinding unit. A sheet conveyed from sheet reversing section B switches switching gate 210 that is positioned to be immediately after entrance 220 of the sheet finisher C through sheet finishing control section 811.

When conducting stapling in sheet finisher C, the sheet finishing control section 811 controls to guide sheets to conveyance path 230 to stack them on movable sheet stacker 250 by arranging them one sheet by one sheet. After stacking the established number of sheets, the sheets are ejected on sheet ejection tray 18 as a booklet after being stapled by stapling unit 260. The sheet ejection tray 18 goes down automatically as the number of sheets stacked thereon is increased so that a following booklet to be ejected may operate to avoid jamming.

When a sheet does not need post-processing in the sheet finisher C, the sheet switching gate 210 is switched to the conveyance path 22 side, and the sheet is ejected to sheet ejection tray 240.

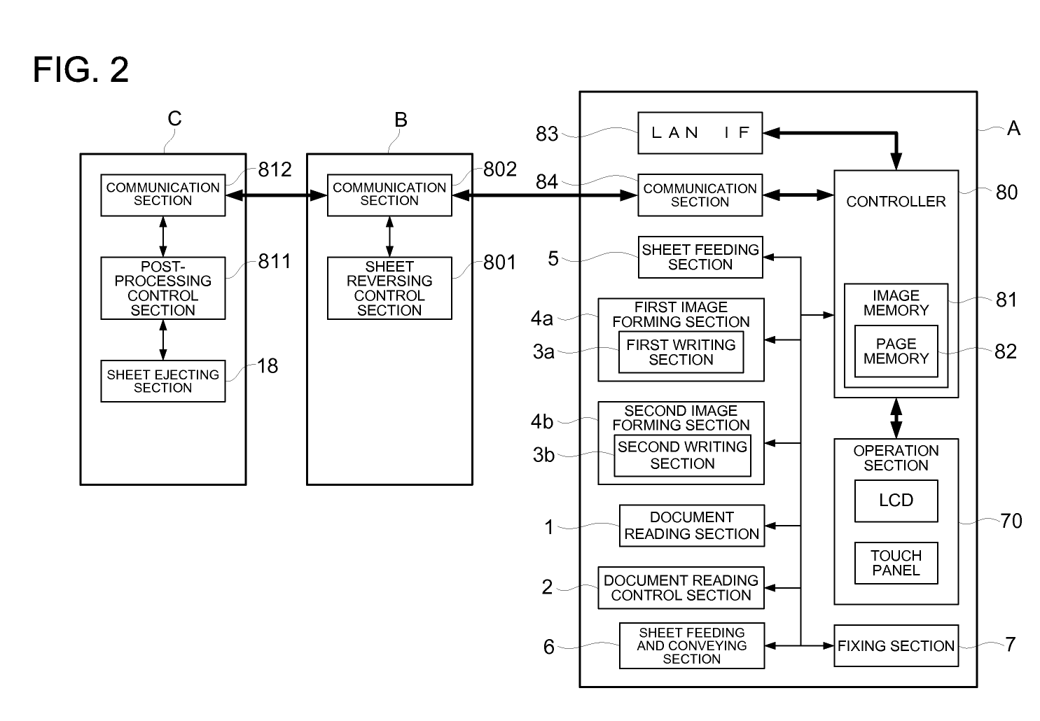

FIG. 2 is a control block diagram relating to the invention. Through communication section 84, the image forming apparatus A conducts an exchange of control signals and data with communication section 802 of reversing section B and with communication section 812 of sheet finisher C. The reversing section B reverses a sheet that is ejected from image forming apparatus A by sheet reversing and control section 801 based on an indication from controller 80. Sheet finisher C can be connected selectively based on application including stapling, center stapling and case-binding, and its operation is carried out by post-processing control section 811 of the connected sheet finisher C. A completed booklet is ejected by sheet ejection section 18 of the sheet finisher C. Communication with image forming apparatus A including signals on the first page and on the last page of a booklet necessary for post-processing through communication section 812 is conducted in synchronization with timing when the sheet is conveyed to the sheet finisher C.

In addition, image forming apparatus A has LAN IF83 always ready for coping with network environment, and it can receive printed data from a personal computer (hereinafter called PC) connected to the network.

Controller 80 feeds out sheets one sheet by one sheet from sheet feeding section 5 or from large capacity sheet tray LT to convey them with sheet feeding and conveying section 6, and fixes toner images with fixing section 7 after forming toner images with image forming section 4 and transferring them onto the sheet, and controls up to sheet ejection. Then, image data made from image data read into image memory 81 in controller 80 from document reading section 1 and from printing data received from PC through LAN IF are stored on a page unit. Image data are stored in page memory 82 that is for assigning image data properly to two image forming sections, by changing page order by causing them to correspond to the order of printing.

In addition, the controller 80 controls operation section 70 as an interface with a user. The operation section 70 can cause a user to select many functions including post-processing by cooperating with LCD through a touch panel, and notifies the controller 80 of its contents, in addition to conducting an indication of the state of image forming apparatus A, an indication of contents of the running job and an indication of the selected functions.

Now, an explanation will be given about how page images are printed by two image forming sections 4a and 4b in the case of continuous two-sided printing, and how a booklet is made in the sheet finisher C by controlling sheet reversing section B, in operations relating to the present invention, including a relationship with facing pages. From now on, all explanations will be given under the condition that 8 pages of document are printed on 4 pages of sheets on the basis of continuous two-sided printing. Further, in the present explanation, a surface that faces upward when the sheet printed on its both sides is ejected into a sheet ejection tray (for example, sheet stacker 250) is called “an obverse surface” and a surface that faces downward is called “a reverse surface” In other words, when the sheet is not reversed in terms of the obverse and the reverse in sheet reversing section B, a surface printed by the first image forming section 4a is “an obverse surface” and a surface printed by the second image forming section 4b is “a reverse surface”, and when the sheet is reversed by sheet reversing section B, the obverse surface and the reverse surface are inverted.

First, an explanation will be given by using an illustration of “a regular mode” in FIGS. 3A-3C. FIG. 3A shows pages of image data of document to be printed by the first image forming section 4a and the second image forming section 4b. The first page is printed on the reverse surface of the first sheet by the second image forming section 4b, and the second page is printed on the obverse surface of the first sheet by the first image forming section 4a. In the same way as in the foregoing, printing is repeated up to the fourth sheet, and with respect to the reverse surface of each sheet, odd number pages are printed by the second image forming section 4b, while, on the obverse surface of each sheet, even number pages are printed by the first image forming section 4a, and the sheet is ejected to sheet finisher C. In this case, in the sheet reversing section B, the sheet is not conveyed to reversing path 150, and is ejected to sheet finisher C while keeping its direction.

When conducting staple bookbinding in sheet finisher C for four sheets prepared by the aforesaid method, the sheets are stacked on a sheet stacker to be stapled as shown in FIG. 3B. Then, with respect to the booklet after the bookbinding, the 1^{st} page becomes to be a front cover and 8^{th} page becomes to be a back cover as shown in FIG. 3C. In the group of the 2^{nd} page up to the 7^{th} page, and two pages (2^{nd} page and 3^{rd} page, 4^{th} page and 5^{th} page, or 6^{th} page and 7^{th} page) which become a combination to face each other in the ejected state as in FIG. 3B, become facing pages as shown in FIG. 3B. In addition, when document data are presentation data in a similar color or are continuous photographic images, a sense of discomfort is caused on image quality of the facing pages, because all of them are printed separately by image forming sections 4a and 4b separately.

As a method to solve this problem, “a two-page spread image quality coincident mode” was established in the invention. Its operations will be explained as follows, referring to the “two-page spread image quality coincident mode” in each of FIGS. 4A-4C. In the same way as in the “regular mode”, FIG. 4A shows how two image forming sections 4a and 4b conduct assigning printing for document data of eight pages. What is characteristic is a 2^{nd} sheet and a 4^{th} sheet wherein allocation of pages for these 2^{nd} sheet and 4^{th} sheet alone is opposite to that in “the regular mode”. The reason for this is that continuous pages to be facing pages in the case of bookbinding for a booklet in sheet finisher C are printed on different sheets continuously by the same image forming section 4a or by the same image forming section 4b.

Namely, N^{th} page is printed on a back surface of a preceding sheet with the second image forming section 4b and (N+1)^{th} page is printed on a front surface of the preceding sheet with the first image forming section 4a, and when printing (N+2)^{th} page on a following sheet, the (N+2)^{th} page is printed on the front surface by the use of the first image forming section 4a that is the same as that for the (N+1)^{th} page. Owing to this operation, (N+1)^{th} page and (N+2)^{th} page which are in the state of the two-page spread as a booklet are printed by the same image forming section, and a two-page spread having no sense of discomfort can be obtained.

However, the 2^{nd} sheet and the 4^{th} sheet in FIG. 4A are conveyed to reversing path 150 through sheet reversing section B, to be reversed and ejected to sheet finisher C, because page order of the completed booklet cannot be adjusted if the sheets are ejected as they are to be subjected to post-processing. This operation is shown by both-arrow marks under the sheets.

As a result, sheets and printed pages in the case of bookbinding of the booklet in the sheet finisher C are stacked as shown in FIG. 4B, and the booklet after the bookbinding is resulted to be one shown in FIG. 4C. In this case, two pages (2^{nd} page and 3^{rd} page, 4^{th} page and 5^{th} page, or 6^{th} page and 7^{th} page) representing facing pages are printed by the same image forming section, thus, a sense of discomfort is not caused on image quality of presentation data in a similar color and on continuous photographic images.

Further, the invention has “specified page selection mode”. This mode is one wherein an indication of image quality coincident is possible for each of facing pages by utilizing operation section 70, when bookbinding a booklet in sheet finisher C for a document which has been read or for image data indicated for printing.

The operations of the aforesaid mode will be explained as follows, referring to the “specified page selection mode” in each of FIGS. 5A-5C. When this indication is conducted, printing for the indicated facing pages is carried out by utilizing the same image forming section, and page adjustment for preparing a booklet in sheet finisher C is carried out by reversing and ejecting the sheet in sheet reversing section B as occasion demands. FIG. 5A shows how two image forming sections 4a and 4b conduct assigning printing for document data of eight pages. When facing pages are 2^{nd} and 3^{rd} pages, the 2^{rd} and the 3^{rd} page are printed continuously in the same image forming section. In this case, printing is conducted for the 3^{rd} page also on an obverse surface of the following sheet with the same first image forming section 4a, because the 2^{nd} page has been printed on an obverse surface of the sheet with the first image forming section 4a. Further, both-arrow mark under the sheet show that the 2^{nd} sheet is reversed and ejected for preparing a booklet in sheet finisher C.

In this “specified page selection mode”, with respect to a sheet and a page for printing the sheet is stacked as shown in FIG. 5B, and a booklet after the bookbinding becomes to be in FIG. 5C. In this case, 2^{nd} and 3^{rd} pages to be facing pages are printed by the same image forming section, thus, a sense of discomfort is not caused on image quality of presentation data in a similar color and continuous photographic images, which is the same as the “two-page spread image quality coincident mode”.

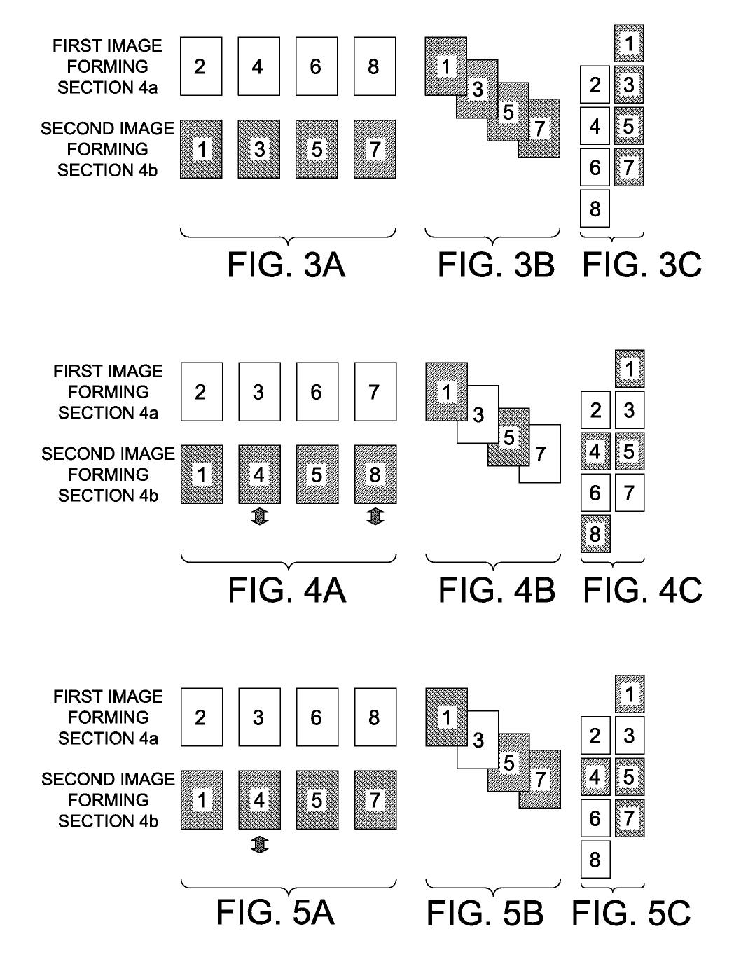

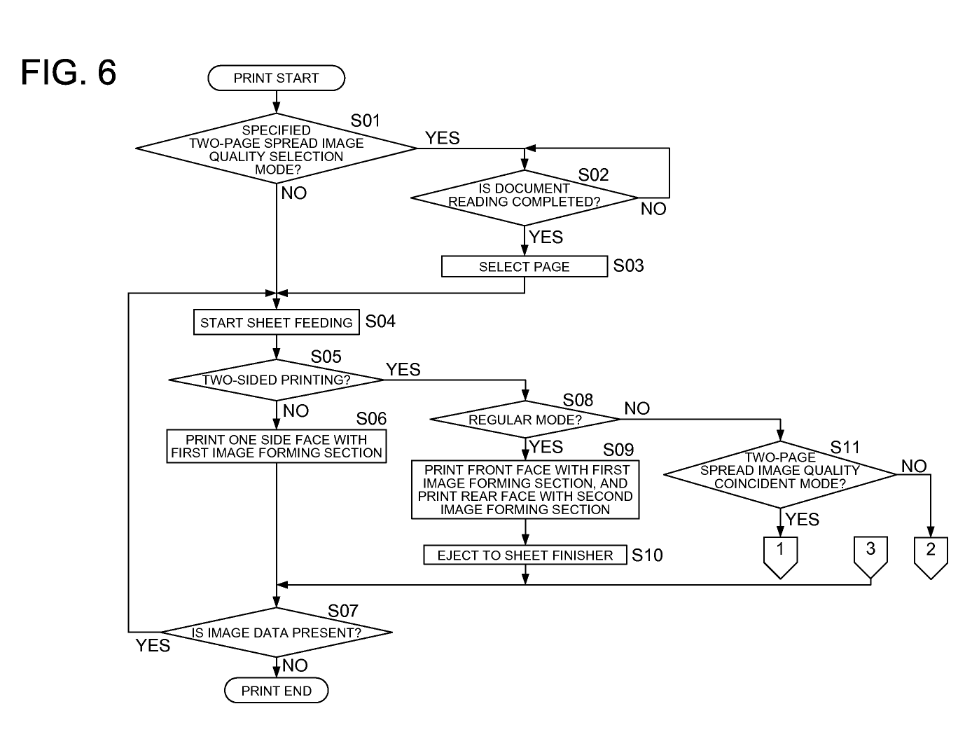

Each of FIGS. 6-7, is a flow chart for control relating to the invention. First, control of the invention will be explained, referring to FIG. 6. After printing is started, “specified page selection mode” in two-sided printing is confirmed whether it is selected or not (step S01). In this confirmation, operation section 70 is caused to indicate all pages to be printed in the order of facing pages, for selecting a specified page, in the “specified page selection mode”, and a user is caused to decide the same image quality from image qualities of facing pages.

When the “specified two-page spread image quality selection mode” is selecting (step S01: Yes), the user is left untouched until reading of a document is completed (step S02: No). When the reading of the document is completed (step S02: Yes), a page requiring the same image quality is selected to be specified from facing pages by utilizing operation section 70 (step S03). A method for selecting operations in the operation section 70 will be described later.

When page selection is completed under the “specified page selection mode”, sheet feeding from sheet feeding section 5 or from large capacity sheet tray LT is started (step S04), in the same way as in (step S01: No) such as “regular mode” and “two-page spread image quality coincident mode” which are other than the “specified page selection mode”. In this case, it is identified whether printing is two-sided printing or not (step S05), and when the printing is one side printing (step S5: No), the one side printing is carried out by using only the first image forming section 4a. Further, presence or absence of image data for printing on the following page is identified (step S07), and when the image data are in existence (step S07: Yes), a flow jumps to start of sheet feeding in step S04 to continue processing of printing for the next page. When the image data are absent (step S07: No), it means that printing is entirely completed, and printing job is terminated.

In the case of two-sided printing in step S05 (step S05: Yes), two-sided printing is divided into three modes suggested by the invention, and when the mode is the “regular mode” (step S08: Yes) after being confirmed in terms of a mode (step S08) for the regular mode, following controls are carried out.

When the mode is “regular mode” in step S08, a page representing a surface of a sheet in the first image forming section 4a is printed on each sheet, and a page representing the other side of the sheet in the second image forming section 4b is printed (step S09). This “regular mode” is a simultaneous two-sided printing mode through one passage that is capable of dealing with two-sided printing at the highest speed and at the highest productivity. Designated pages are printed simultaneously on the surface and the other side of a sheet to be transferred, and it is ejected to sheet finisher C after being fixed (step S10). In the case of this mode, controller 80 supplies optimum image data to two image forming sections 4a and 4b so that booklets may be made without page adjustment in sheet finisher C. After the sheet is ejected to the sheet finisher C, a flow jumps to step S07 to confirm presence or absence of image data for remaining page printing, and when remaining image data are in existence, printing is continued.

When a mode is not “regular mode” in step S08 (step S08: No), “two-page spread image quality coincident mode” is confirmed whether it is selected or not (step S11). When the “two-page spread image quality coincident mode” is selected (step S11: Yes), a flow jumps to step S12 in FIG. 7. When the “two-page spread image quality coincident mode” is not selected (step S11: No) in step 11, the mode is “specified page selection mode” and a flow jumps to step S17 in FIG. 7.

An explanation will be given as follows, starting from step S12 in the case of the “two-page spread image quality coincident mode” in FIG. 7. First, a sheet is confirmed whether it is an (odd number)^{th} page or an (even number)^{th} page (step S12), and when the sheet is the (odd number)^{th} page (step S12: Yes), printing is carried out in the same way as in the “regular mode” (step S13). For example, for N^{th} page, printing is conducted on the back surface of the first sheet in the second image forming section 4b, and for the (N+1)^{th} page, printing is conducted on the obverse surface of the first sheet in the first image forming section 4a. The sheet on which the printing is completed on both surfaces is ejected to sheet finisher C as it is after fixing (step S14). After that, a flow jumps to step S07 in FIG. 6 to confirm continuation of printing.

When the sheet is the (even number)^{th} page (step S12: no), a printing surface of the sheet and a printing surface of the (odd number)^{th} page are made to be opposite each other to be printed (step S15). For example, (N+2)^{th} page is printed by the first image forming section 4a on an obverse surface of the second sheet, and then, printing is conducted for odd numbered sheets and even numbered sheets. Then, (N+3)^{th} page is printed by the second image forming section 4b on the back surface of the second sheet. After this, when no action is taken, pages of a booklet are not put in good order in the case of bookbinding in sheet finisher C. Therefore, the second sheet is reversed by sheet reversing section B (step S16) to be ejected to sheet finisher C through flow jumping to step S14.

On the other hand, if “specified page selection mode” is selected in step S11 in FIG. 6, a two-page spread same image forming section in FIG. 7 is confirmed whether it is used or not (step S17). This confirmation is to identify whether the page to be printed on the next sheet uses the image forming section identical to the page printed already on the selected facing pages, when the user conducts printing of the selected facing pages. When it is not the selected facing pages (step S17: No), a page on the obverse surface of a sheet is printed by the first image forming section 4a, and a page on the back surface of the sheet is printed by the second image forming section 4b, in the same way as in the “regular mode” (step S18), and then, the sheet is ejected to sheet finisher C (step S14).

In the case of two-page spread of same image forming section use (step S17: Yes), printing is conducted (step S19) in the way wherein pages are opposite to those made by the output method for facing pages which become a pair finished already in terms of printing. Namely, when (N+1)^{th} page of the sheet finished in terms of printing is printed on an obverse surface of the sheet by the first image forming section 4a, (N+2)^{th} page is also printed on an obverse surface of the following sheet by the same first image forming section 4a. Further, when (N+1)^{th} page of the sheet completed already in terms of printing is printed on the back surface of the sheet by the second image forming section 4b, (N+2)^{th} page is also printed on the back surface of the following sheet by the second image forming section 4b.

In this case, when (N+2)^{th} page is subjected to print an obverse face in the first image forming section 4a (step S20: Yes), the sheet is reversed by reversing and ejecting section B (step S21), and is ejected to sheet finisher C (step S14). When (N+2)^{th} page is not subjected to the obverse surface printing by the first image forming section 4a (step S20: No), the sheet is ejected to sheet finisher C as it is without being reversed (step S14). These judgments and actions for them are for the page adjustment in the case of bookbinding of booklets in sheet finisher C.

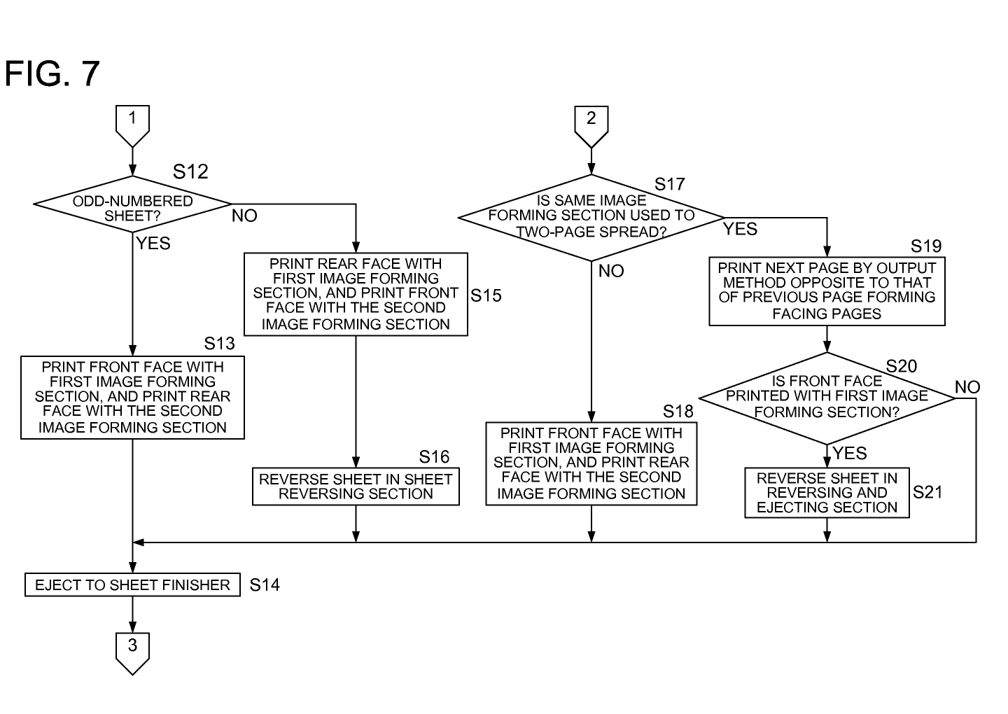

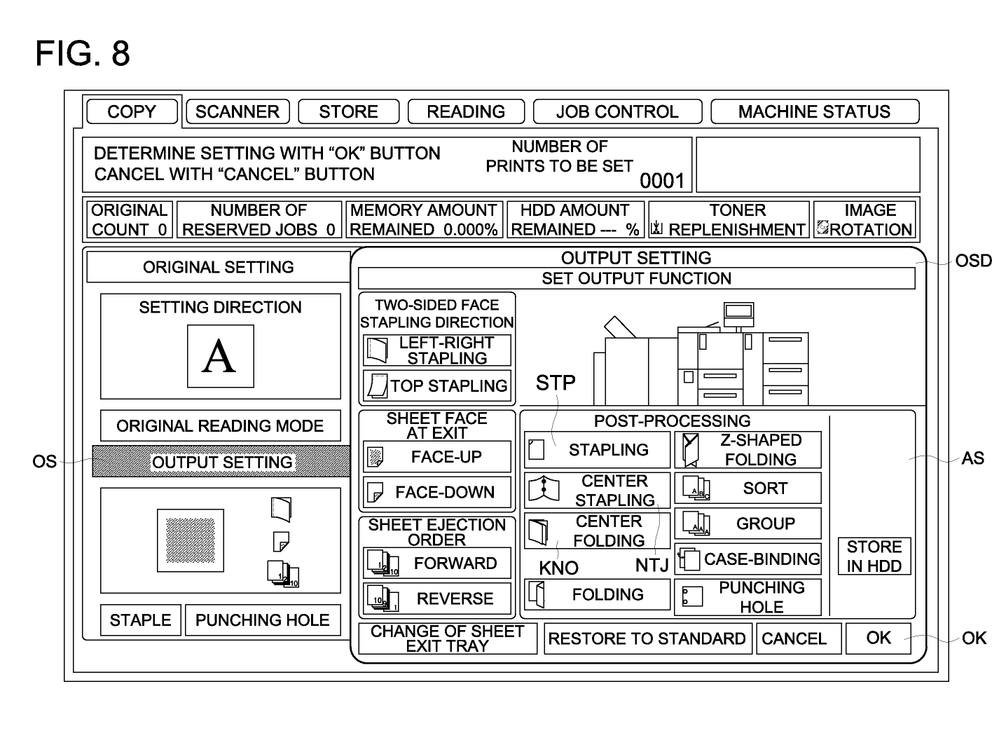

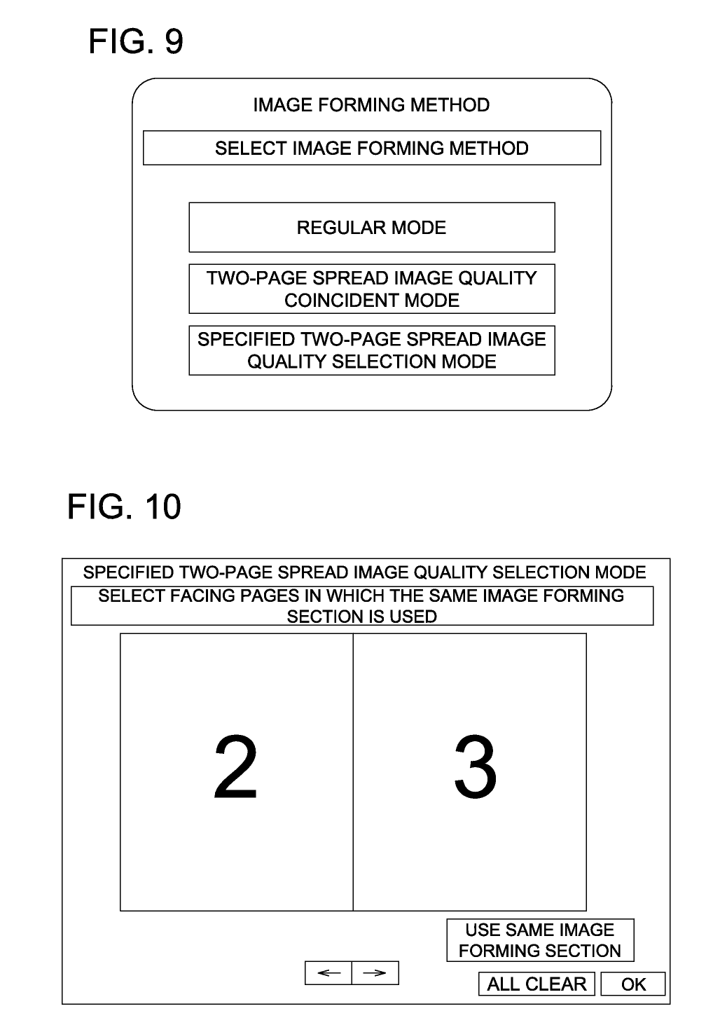

Now, an example for each of output setting methods for three modes will be explained as follows, referring to the output setting images relating to the present examples in FIGS. 8 and 9 and to the specified page selection image in FIG. 10. FIG. 8 shows an output setting screen in operation section 70. In FIG. 8, if output setting OS is depressed, screen of output setting OSD appears. When stapling STP, center stapling NTJ and center folding KNO button are depressed for selection from post-processing AS in output setting screen OSD, screens in FIG. 9 become to be in the pop-up state. In this particular case, buttons for “regular mode”, “two-page spread image quality coincident mode” and for “specified page selection mode” appear, and any one of the image forming methods can be selected. After the selection, a flow returns to the output setting screen OSD in FIG. 8 and OK button OK is depressed, thus, the mode setting is terminated.

However, in the “specified page selection mode”, if image data to be printed are taken in image forming section A, a screen of the specified page selection screen mode in FIG. 10 is indicated before the start of printing. Each page screen indicates an image of facing images of a booklet, based on image data which have been read into image forming section A. Facing pages which need to be coincident in terms of image quality with a screen of this specified page selection mode are moved by arrow buttons on the right and left, and selection is conducted by depressing buttons which use the same image forming sections. This selection is possible for plural facing pages. When the selection for all pages to be coincident in terms of image quality is completed, the OK button is depressed to terminate. Further, when facing pages are required to be selected again, it is possible to cancel all of the facing pages which have been selected.

In the present example, there has been given the explanation wherein two image forming sections are arranged vertically against the sheet conveyance path as shown in FIG. 1, and toner polarities for respective image forming sections are made to be opposite to each other. However, it is also possible to arrange so that two image forming sections are provided to be put in order on one side of the sheet conveyance path, and a fixing section and a sheet reversing section are provided in a space between the two image forming sections. It is also possible to select composition wherein the two image forming sections are made to be the same as the present example, a fixing unit is provided between the two image forming sections, and polarities of the toner are changed to be the same. Further, if the composition is selected to be one wherein a sheet conveyance path is provided after the fixing unit of any one of image forming sections so that the same image forming section may be used again, it is possible to provide all pages “perfect image quality coincident mode” wherein only one image forming section is used for all pages.

What is claimed is:

1. An image forming apparatus comprising:
(a) two image forming sections each of which is capable of printing an image on an obverse surface or a reverse surface of a recording sheet;
(b) a sheet reversing section which reverses the recording sheet on which the image has been printed; and
(c) a controller, when a continuous two-sided printing is carried out, which causes the two image forming sections to print an image corresponding to image data on an Nth page and an image corresponding to image data on an (N+1)th page onto a preceding recording sheet, respectively, causes the same image forming section as the image forming section that has formed the image on the (N+1)th page to print an image corresponding to image data on an (N+2)th page onto a following sheet, causes the sheet reversing section to reverse the sheet on which the image of the (N+2)th page has printed before the sheet is ejected from the image forming apparatus, and then controls a sheet ejection so that a surface of the (N+1)th page of the preceding sheet faces a surface of the (N+2)th page of the following sheet.

2. The image forming apparatus of claim 1, further comprising a sheet finisher that conducts a post-processing on a sheet with image and forms a booklet, wherein the controller controls the two image forming sections so that two pages of images of the booklet to be a two-page spread, are printed by the same image forming section.

3. The image forming apparatus of claim 2, further comprising a selectable section which enables a user to select so that two pages of images of the booklet to be a specific two-page spread are printed by the same image forming section, before the booklet is formed in the sheet finisher.
